(19) United States
(12) Patent Application Publication
(10) Pub. No.: US 2017/0013484 A1
(43) Pub. Date: Jan. 12, 2017

(54) SERVICE FAILURE IN COMMUNICATIONS NETWORKS

(71) Applicant: TELEFONAKTIEBOLAGET LM ERICSSON (PUBL), Stockholm (SE)

(72) Inventors: Qingyan LIU, Beijing (CN); Vincent HUANG, Sollentuna (SE); Vincent (Zhili) WU, Beijing (CN)

(21) Appl. No.: 15/119,255

(22) PCT Filed: Feb. 17, 2014
(86) PCT No.: PCT/CN2014/072153

§ 371 Date: Aug. 16, 2016

(51) Int. Cl. H04W 24/04; H04W 24/10

(52) U.S. Cl. CPC H04W 24/04; H04W 24/10; H04L 43/16

(57) ABSTRACT

Apparatuses and methods providing indications of service failure in a communications network. At least one N-dimensional vector of key performance indicator values is acquired from at least one network equipment device. An outlier score is determined for the at least one N-dimensional vector by using an L-valued outlier scoring function based on N-dimensional regions Rk, k=1, L, where L>1, and where region Ri is at least partly enclosed by region Rj, and where the outlier score for the N-dimensional vector is dependent on in which of the N-dimensional regions Rk the N-dimensional vector is located. An indication of service failure is determined for the at least one network equipment device based on the outlier score for the at least one N-dimensional vector.

### TECHNICAL FIELD

Embodiments presented herein relate to communications networks, and particularly to a method, a network node, a computer program, and a computer program product for indicating service failure in a communications network.

### BACKGROUND

In communication networks, there is always a challenge to obtain good performance and capacity for a given communications protocol, its parameters and the physical environment in which the communication network is deployed.

One factor which may be used as an indicator of the performance and capacity communication networks is so-called service key performance indicator (KPI) data for network equipment devices such as gateways, routers, etc. Such KPI data may be collected periodically so as to detect service failure based on the data. The set of KPI data is large and grows rapidly. For example, even in a very small subset of one client network, 10,000 KPI readings from more than 1600 network equipment devices may be collected every 15 minutes. The volume and the unceasing pace of data thus cause any manual approach solely relying on experts impractical.

Currently employed mechanisms for handling KPI data in communications networks suffer from slow response and limited scalability due to the manual inspection of domain experts, or high error rates of conventional techniques that lack the flexibility of modeling data variety and input from experts.

Each KPI record has a timestamp and an indicator reading. A network equipment device, such as a router of MSC_MGW_BSC traffic, may generate multiple KPI records at a time, each of which has a meaning, e.g., a congestion rate. The vector of all KPI readings of each network equipment device at each timestamp can be taken as a point in a high dimensional space. Significant change from normal positions in the space may indicate service overload or degradation. Such points are of interest and are defined as outlier candidates.

Examples of existing automatic outlier detection technologies are generic clustering methods (e.g. k-means), which group KPI points at all timestamps into a preset number of clusters. Points in a smaller cluster are taken as outliers. However, KPI data points of a network equipment device may form one cluster only, accompanied with a few outlier points. In such cases generic clustering methods such as k-means will produce a single trivial cluster of all points, incapable of finding any outlier. If the generic clustering method is set to divide points into two or more clusters, it often achieves too balanced splits, causing too many normal points falsely alarmed as outliers.

Another existing clustering-based outlier detection approach, as presented in “Support vector data description” by Tax, D. M. J., and Duin, R. P. W. in Machine Learning, 2004, 54(1): 45-66, adopts a minimum enclosing ball (MEB) formulation or a relaxed variant to covers all/part of data. The ball center is a weighted mean of data points on or outside the ball. All points outside the ball are taken as outliers. One issue with the MEB approach is that the spherical boundary is heavily influenced by peripheral data, thus causing unrealistic clustering boundaries too aligned to outliers.

Hence, there is still a need for an improved handling of KPI data in communications networks in order to indicate service failure.

### SUMMARY

An object of embodiments herein is to provide improved handling of KPI data in communications networks in order to indicate service failure.

The inventors of the enclosed embodiments have realized that existing approaches, as exemplified above, neglect the temporal nature of KPI data point values. Existing approaches do not take into account that KPI data point values keep behaving abnormally for a certain period shall be more likely taken as outliers.

The inventors of the enclosed embodiments have further realized that existing approaches, as exemplified above, also neglect the interdependencies of multiple interconnected network equipment devices. Existing approaches do not take into account that the KPI data point values of multiple network equipment device may be considered together to identify service failure of one or more such network equipment devices.

According to a first aspect there is presented a method for indicating service failure in a communications network. The method is performed by a network node. The method comprises acquiring at least one N-dimensional vector of key performance indicator (KPI) values from at least one network equipment device.

The method comprises determining an outlier score for the at least one N-dimensional vector by using an L-valued outlier scoring function based on N-dimensional regions Rk, k=1, . . . , L, where L>1, and where region Ri is at least partly enclosed by region Rj, and wherein the outlier score for the N-dimensional vector is dependent on in which of the N-dimensional regions Rk the N-dimensional vector is located. The method comprises determining an indication of service failure for the at least one network equipment device based on the outlier score for the at least one N-dimensional vector.

Advantageously this provides improved handling of KPI data in communications networks and further provides improved service failure indication.

Advantageously this provides a robust system for outlier detection.

Advantageously this enables temporal changes in KPI data to be considered for outlier detection.

Advantageously this enables dependencies among network equipment devices to be considered when determining service failure.

According to a second aspect there is presented a network node for indicating service failure in a communications network. The network node comprises a processing unit and a non-transitory computer readable storage medium. The non-transitory computer readable storage medium comprises instructions executable by the processing unit. The network node is operative to acquire at least one N-dimensional vector of key performance indicator (KPI) values from at least one network equipment device. The network node is operative to determine an outlier score for the at least one N-dimensional vector by using an L-valued outlier scoring function based on N-dimensional regions Rk, k=1, . . . , L, where L>1, and where region Ri is at least partly enclosed by region Rj, and wherein the outlier score for the N-dimensional vector is dependent on in which of the N-dimensional regions Rk the N-dimensional vector is located. The network node is operative to determine an indication of service failure for the at least one network equipment device based on the outlier score for the at least one N-dimensional vector.

According to a third aspect there is presented a computer program for indicating service failure in a communications network, the computer program comprising computer program code which, when run on a processing unit, causes the processing unit to perform a method according to the first aspect.

According to a fourth aspect there is presented a computer program product comprising a computer program according to the third aspect and a computer readable means on which the computer program is stored.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2a is a schematic diagram showing functional units of a network node according to an embodiment;

FIG. 2b is a schematic diagram showing functional modules of a network node according to an embodiment;

FIG. 2c is a schematic diagram showing operational modules of a network node according to an embodiment;

FIG. 3 shows one example of a computer program product comprising computer readable means according to an embodiment;

FIGS. 4 and 5 are flowcharts of methods according to embodiments; and

FIG. 6 schematically illustrates an example of 2-dimensional regions according to an embodiment;

FIG. 7 schematically illustrates determination of outlier score according to an embodiment based on the 2-dimensional regions of FIG. 6;

FIG. 8 schematically illustrates an example of 2-dimensional regions according to an embodiment;

FIG. 9 schematically illustrates determination of outlier score according to an embodiment based on the 2- dimensional regions of FIG. 8;

FIG. 10 schematically illustrates a 3- dimensional tube of regions according to an embodiment; and

FIG. 11 schematically illustrates a user interface according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

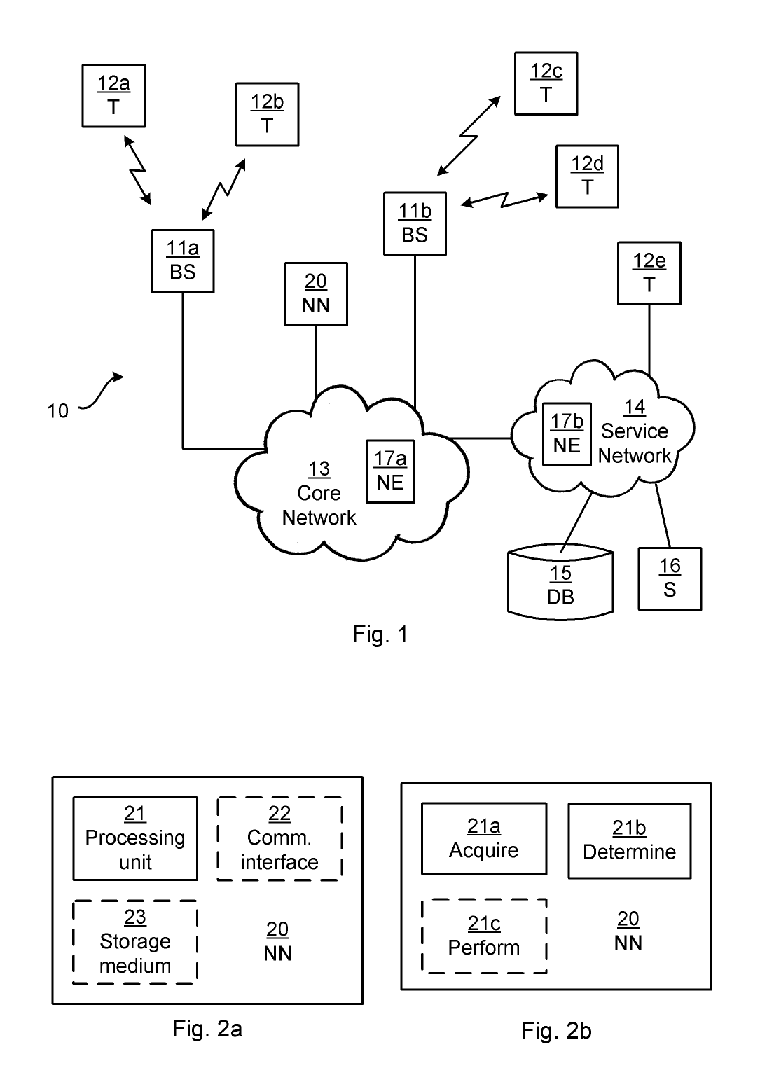

FIG. 1a shows a schematic overview of an exemplifying communications network 10 where embodiments presented herein can be applied. The communications network 10 comprises base stations (BS) 11a, 11b, such as any combination of Base Transceiver Stations, Node Bs, Evolved Node Bs, WiFi Access Points, etc. providing network coverage over cells (not shown). An end-user terminal device (T) 12a, 12b, 12c, 12d, such as mobile phones, smartphones, tablet computers, laptop computers, user equipment, etc., positioned in a particular cell is thus provided network service by the base station 11a, 11b serving that particular cell. As the skilled person understands, the communications network 10 may comprise a plurality of base stations 11a, 11b and a plurality of end-user terminal devices 12a, 12b, 12c, 12d operatively connected to at least one of the plurality of base stations 11a, 11b.

The base stations 11a, 11b are operatively connected to a core network 13. The core network 13 may provide services and data to the end-user terminal devices 12a, 12b, 12c, 12d operatively connected to the base stations 11a, 11b from an external service network 14. An end-user terminal device 12e may have a wired connection to the external service network 14. The service network is operatively connected to at least one database 15, such as a database storing Internet files, and at least one server 16, such as a web server. The base stations 11a, 11b, the database 15, and the server 16 may be collectively referred to as network equipment devices. The core network 13 as well as the service network 14 may comprise further network equipment devices 17a, 17b. Examples of network equipment devices thus include, but are not limited to gateways, routers, network bridges, switches, hubs, repeaters, multilayer switches, protocol converters, bridge routers, a proxy servers, firewall handlers, network address translators, multiplexers, network interface controllers, wireless network interface controllers, modems, Integrated Services for Digital Network (ISDN) terminal adapters, line drivers, wireless access points, radio base stations.

The communications network 10 comprises a network node (NN) 20. Details of the network node 20 will be provided below.

At least parts of the communications network 10 may generally comply with any one or a combination of W-CDMA (Wideband Code Division Multiplex), LTE (Long Term Evolution), EDGE (Enhanced Data Rates for GSM Evolution, Enhanced GPRS (General Packet Radio Service)), CDMA2000 (Code Division Multiple Access 2000), WiFi, microwave radio links, HSPA (High Speed Packet Access), etc., as long as the principles described hereinafter are applicable.

The embodiments disclosed herein relate to indicating service failure in a communications network 10. In order to indicate service failure in a communications network there is provided a network node 20, a method performed by the network node 20, a computer program comprising code, for example in the form of a computer program product, that when run on a processing unit (such as a processing unit of the network node), causes the processing unit to perform the method.

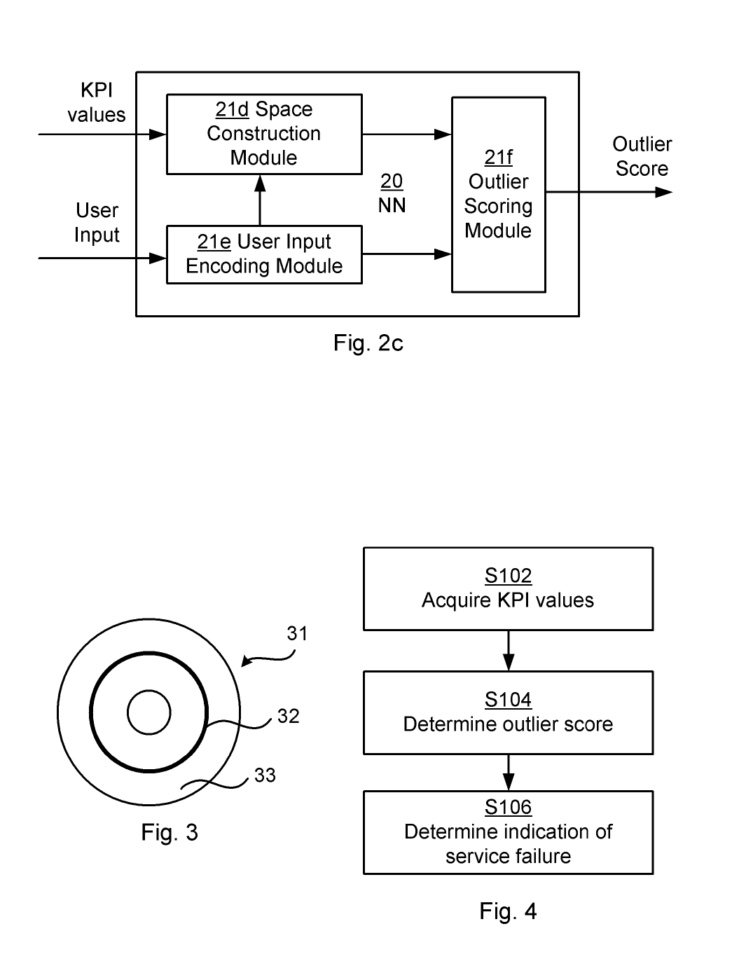

FIG. 2a schematically illustrates, in terms of a number of functional units, the components of a network node 20 according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 31 (as in FIG. 3), e.g. in the form of a storage medium 23. Thus the processing unit 21 is thereby arranged to execute methods as herein disclosed. The a storage medium 23 may also comprise persistent storage, which, for example, can be any single one or combination of magnetic memory, optical memory, solid state memory or even remotely mounted memory. The network node 20 may further comprise a communications interface 22 for communications with entities, such as network equipment devices, of the communications network 10. As such the communications interface 22 may comprise one or more transmitters and receivers, comprising analogue and digital components and a suitable number of antennas for wireless communications or ports for wired communications. The processing unit 21 controls the general operation of the network node 20 e.g. by sending data and control signals to the communications interface 22 and the storage medium 23, by receiving data and reports from the communications interface 22, and by retrieving data and instructions from the storage medium 23. Other components, as well as the related functionality, of the network node 20 are omitted in order not to obscure the concepts presented herein.

FIG. 2b schematically illustrates, in terms of a number of functional modules, the components of a network node 20 according to an embodiment. The network node 20 of FIG. 2b comprises a number of functional modules; an acquire module 21a, and a determine module 21b. The network node 20 of FIG. 2b may further comprises a number of optional functional units, such as a perform module 21c. The functionality of each functional module 21a-c will be further disclosed below in the context of which the functional modules may be used. In general terms, each functional module 21a-c may be implemented in hardware or in software.

The processing unit 21 may thus be arranged to from the storage medium 23 fetch instructions as provided by a functional module 21a-c and to execute these instructions, thereby performing any steps as will be disclosed hereinafter.

FIG. 2c schematically illustrates, in terms of a number of operational modules the components of a network node 20 according to an embodiment. The network node 20 of FIG. 2c comprises a space construction module 21d, a user input encoding module 21e, and an outlier scoring function 21f. In general terms, the space construction module 21d may be configured to transform received KPI data points and to map them into a space with an augmented dimension. Augmentation techniques include, but are not limited to, concatenating the readings of multiple network equipment devices, adopting distance measures that decay as time elapses, and generating multiple regions where the (transformed) KPI points are located. In general terms, the user input encoding module 21e may be configured to accept outlier score input from users/experts (or other existing outlier detection systems) for a specific KPI data and provides such data to the space construction module 21d and/or the outlier scoring function 21f. The outlier scoring module 21f may be configured to determine an outlier score for input KPI values, for example by counting how many times each KPI values fall outside the regions determined by the space construction module 21d, where each region is associated with a likelihood score of classifying KPI values as an outlier. Detailed operations performed by each module 21d-f will be further disclosed below. Each module 21d-f may be provided in hardware, software, or any combination thereof.

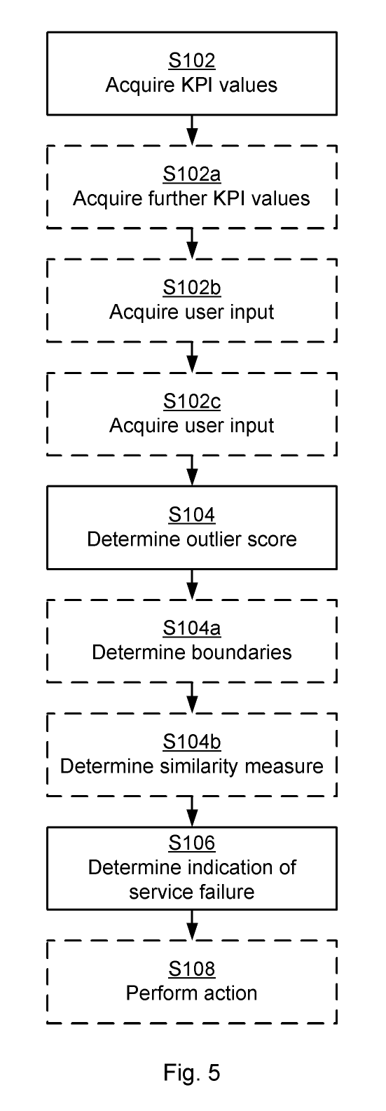

FIGS. 4 and 5 are flow chart illustrating embodiments of methods for indicating service failure in a communications network 10. The methods are performed by a processing unit 21, such as the processing unit 21 of the network node 20. The methods are advantageously provided as computer programs 32. FIG. 3 shows one example of a computer program product 31 comprising computer readable means 33. On this computer readable means 33, a computer program 32 can be stored, which computer program 32 can cause the processing unit 21 and optionally thereto operatively coupled entities and devices, such as the communications interface 22 and the storage medium 23 to execute methods according to embodiments described herein. The computer program 32 and/or computer program product 31 may thus provide means for performing any steps as herein disclosed.

In the example of FIG. 3, the computer program product 31 is illustrated as an optical disc, such as a CD (compact disc) or a DVD (digital versatile disc) or a Blu-Ray disc. The computer program product 31 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the computer program 32 is here schematically shown as a track on the depicted optical disk, the computer program 32 can be stored in any way which is suitable for the computer program product 31.

Reference is now made to FIG. 4 illustrating a method for indicating service failure in a communications network 10 according to an embodiment. The method is performed by the network node 20.

The indication of service failure is based on readings from one or more network equipment devices 11a, 11b, 15, 16, 17a, 17b. The processing unit 21 of the network node 20 is therefore arranged to, in a step S102, acquire at least one N-dimensional vector V1 of key performance indicator (KPI) values from at least one network equipment device 11a, 11b, 15, 16, 17a, 17b. The acquiring in step S102 may be performed by executing functionality of the acquire module 21a. The computer program 32 and/or computer program product 31 may thus provide means for this acquiring.

This at least one N-dimensional vector of KPI values is subjected to an outlier scoring function. The processing unit 21 of the network node 20 is arranged to, in a step S104, determine an outlier score for said at least one N-dimensional vector by using an L-valued outlier scoring function. The determining in step S104 may be performed by executing functionality of the determine module 21b. The computer program 32 and/or computer program product 31 may thus provide means for this determining. The L-valued outlier scoring function is based on N-dimensional regions Rk, k=1, . . . , L, where L>1, and where region Ri is at least partly enclosed by region Rj. The outlier score for the N-dimensional vector is dependent on in which of the N-dimensional regions Rk the N-dimensional vector is located. The N-dimensional vector of KPI values may be located in one such N-dimensional region, in more than one such N-dimensional region, or outside all such N-dimensional regions. Examples of N-dimensional regions and how they may be shaped will be provided below.

The processing unit 21 of the network node 20 is then arranged to, in a step S106, determine an indication of service failure for the at least one network equipment device based on the outlier score for the at least one N-dimensional vector. The determining in step S106 may be performed by executing functionality of the determine module 21b. The computer program 32 and/or computer program product 31 may thus provide means for this determining. Examples of how the indication of service failure may be determined based on the outlier score will be provided below.

Embodiments relating to further details of indicating service failure in a communications network 10 will now be disclosed.

As noted above, the at least one N-dimensional vector of KPI values is acquired from at least one network equipment device 11a, 11b, 15, 16, 17a, 17b. One such N-dimensional vector of KPI values may represent KPI values from a plurality of network equipment devices or KPI values from a single network equipment device.

There may be different ways of determining an indication of service failure as in step S106. For example, the determining may be based on comparing the outlier score to a predetermined threshold value. As will be further disclosed below, this predetermined threshold value may in turn be related to a likelihood value.

Reference is now made to FIG. 5 illustrating methods for indicating service failure in a communications network 10 according to further embodiments.

There may be different ways to utilize the indication of service failure as determined in step S106. For example, the indication of service failure may be used as a trigger for an action to be performed. According to an embodiment the processing unit 21 of the network node 20 is therefore arranged to, in an optional step S108, perform an action in response to the indication of failure. There may be different types of actions to be performed. Which action to be performed may relate to the failure indicated, such as on basis of the outlier score determined in step S104 and/or the type of KPI data acquired in step S102. That is, the action may be based on at least one of the outlier score and the N-dimensional vector of KPI values.

There may be different ways to determine the N-dimensional regions as used to determine the outlier score determined in step S104. Different embodiments relating thereto will now be described in turn.

For example, the N-dimensional regions may be defined by enclosing an increasing number of data points within boundaries. These data points may be defined by further acquired KPI values. Hence, one N-dimensional region may enclose a first set of these further acquired KPI values and a further N-dimensional region may enclose a second set of these further acquired KPI values, where the second set comprises more KPI values than the first set, and where the first set and the second set have a non-zero intersection.

Particularly, according to an embodiment the processing unit 21 of the network node 20 is arranged to, in an optional step S102a, acquire at least two further N-dimensional vectors of KPI values from the at least one network equipment device 11a, 11b, 15, 16, 17a, 17b. The acquiring in step S102a may be performed by executing functionality of the acquire module 21a. The computer program 32 and/or computer program product 31 may thus provide means for this acquiring. The processing unit 21 of the network node 20 may then be arranged to, in an optional step S104a, determine the L-valued outlier scoring function by determining N-dimensional boundaries between region Ri and Region Ri+1 for i=1, . . . , L−1. The determining in step S104a may be performed by executing functionality of the determine module 21b. The computer program 32 and/or computer program product 31 may thus provide means for this determining.

According to this embodiment all of the at least two further N-dimensional vectors are enclosed within a first N-dimensional boundary. The first N-dimensional boundary is based on distances between all the further N-dimensional vectors. Further, according to the present embodiment a proper subset of the at least two further N-dimensional vectors is enclosed within a second N-dimensional boundary. The second N-dimensional boundary is based on a distances between vectors of the proper subset. According to an extension of the present embodiment a further proper subset of the at least two further N-dimensional vectors is enclosed by a third N-dimensional boundary. The further proper subset and the proper subset have a non-zero intersection and a non-zero set difference. The third N-dimensional boundary is based on a distances between vectors of the further proper subset.

Examples of how the N-dimensional regions (and corresponding boundaries) may be constructed based on the above disclosed principles will now be disclosed in detail. In general terms, construction of the N-dimensional regions (and corresponding boundaries) may be implemented in the space construction module 21d of FIG. 2c. Hence the N-dimensional regions (and corresponding boundaries) may be based on KPI values and optionally by input received from a user input encoding module 21e. Examples of user input will be provided below.

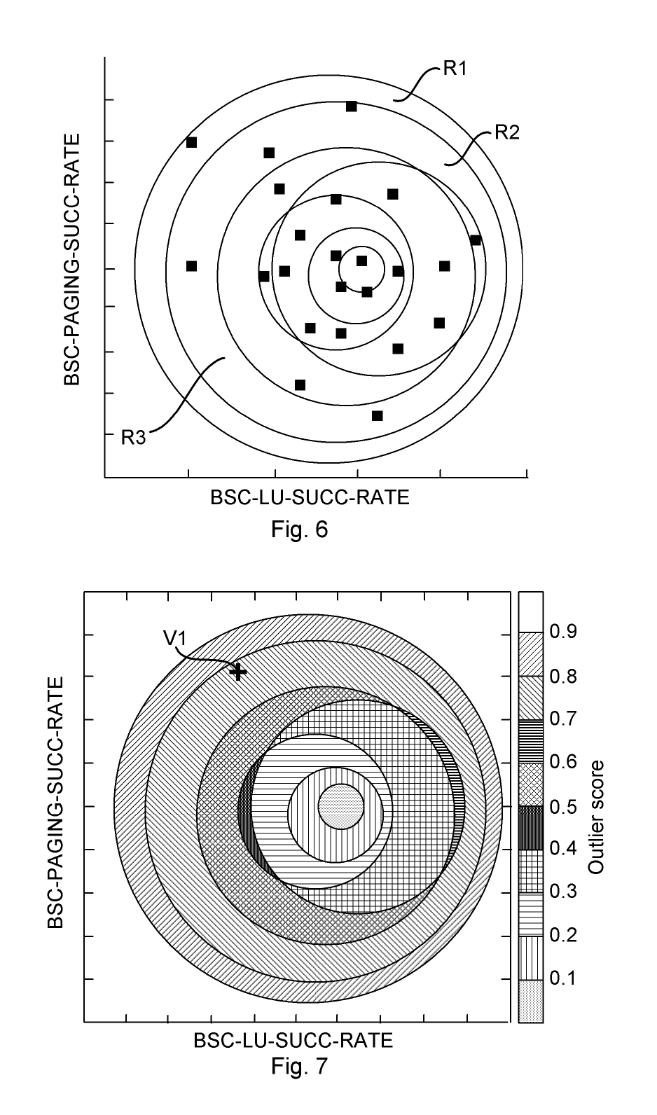

According to a first example, each N-dimensional region is defined by an N-dimensional sphere. Hence, according to an embodiment the N-dimensional regions by default are N-dimensional spheres. FIG. 6 schematically illustrates a first example of 2-dimensional (i.e., N=2) regions, where each region is defined by a sphere. The 2-dimensional regions of FIG. 6 are based on two types of KPI readings being collected so as to represent one 2-dimensional vector of KPI values. Each point, illustrated by a black square, represents one such pair of KPI values. More particularly, the first type of KPI readings are BSC-LU-SUCC-RATE values and the second type of KPI readings are BSC-PAGING-SUCC-RATE values.

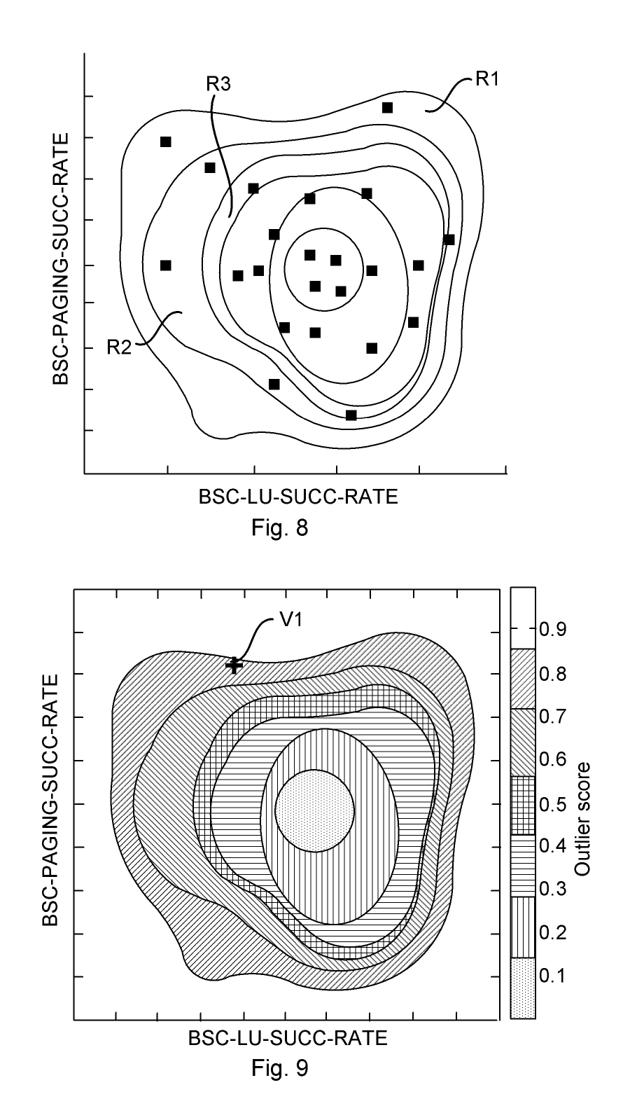

The data points represented by each N-dimensional vector of KPI values may not be limited to be the format of the original KPI readings. According to a second example, the N-dimensional regions are defined by non-linear kernel functions. Hence, according to an embodiment N-dimensional regions are defined by at least one N-dimensional non-linear function. The non-linear kernel functions may have an exponential or a polynomial decay. Through nonlinear kernel functions the N-dimensional vectors of KPI values can be mapped to an N-dimensional feature space in which default spheres are learned for the N-dimensional vectors of KPI values are nonlinearly grouped by boundaries that have more complex shapes than a sphere. FIG. 8 schematically illustrates a second example of 2-dimensional (i.e., N=2) regions, where each region is defined by a sphere having been subjected to a non-linear function.

There may be different ways to shape the N-dimensional boundaries of the N-dimensional regions. Different embodiments relating thereto will now be described in turn.

Each N-dimensional region (for example, each default N-dimensional sphere) can be related to N-dimensional vectors of KPI values in many ways. For example a nonnegative weighting factor may be learnt for each N-dimensional vector of KPI values. Hence, according to an embodiment each N-dimensional vector in each proper subset of the at least two further N-dimensional vectors is associated with a weighting factor. All weighting factors for the further N-dimensional vector in said each proper subset sum up to 1. The weighting factors may be upper-bounded by a positive parameter C. That is, each one of the weighting factors may at most be equal to C, where 0<C<1.

There are many ways to specify the weighting factors. For example, the weighting factors may be determined through optimizing an objective function such that a quantity, e.g., the total summation of the weighted squared distances of all N-dimensional vectors of KPI values to the default sphere center, will be minimized under a specific C value. It is possible to determine a single best C value. But for example by solving special linear complementary problems, optimal weighting factors may be determined for a series of C values.

The weighted combination of all N-dimensional vectors of KPI values may then become the center of a default N-dimensional sphere (possibly with a plurality of weighting factors set to 0), and the radius of the N-dimensional sphere equals the distance from the center to any point that is associated with a weighting factor that is larger than 0 and smaller than C. Hence, this results in N-dimensional regions with N-dimensional boundaries and centers determined by N-dimensional vectors of KPI values on an N-dimensional boundary or within the N-dimensional regions, and which N-dimensional regions are ignorant of N-dimensional vectors of KPI values outside its N-dimensional boundary.

The N-dimensional vectors of KPI values may be associated with a timestamp. There may be different ways to associate each N-dimensional vector of KPI values with a timestamp. For example, each N-dimensional vector may represent KPI values with a common timestamp value. For example, each N-dimensional vector may represent KPI values with at least two different timestamp values. Hence, the resulting outlier score may be valid for one network equipment device 11a, 11b, 15, 16, 17a, 17b or for several network equipment devices 11a, 11b, 15, 16, 17a, 17b.

The outlier score as determined in step S104 may be based on a pairwise similarity measure for each pair of N-dimensional vectors of KPI values. Particularly, according to an embodiment the processing unit 21 of the network node 20 is arranged to, in an optional step S104b, determine a similarity measure based on the timestamp between the at least one N-dimensional vector and at least one previously acquired N-dimensional vector of KPI values associated with a previous timestamp. The determining in step S104b may be performed by executing functionality of the determine module 21 b. The computer program 32 and/or computer program product 31 may thus provide means for this determining. According to this embodiment the outlier score for the at least one N-dimensional vector is further determined based on the similarity measure and an outlier score for the at least one previously acquired N-dimensional vector of KPI values.

Different considerations related thereto will now be disclosed. The similarity of service statuses at two timestamps can be related to their time difference besides their readings. For example, a time difference of 24 hours or 7 days may imply a high level of similarity. Other time differences may also add similarity with an exponential decay factor. Hence, the similarity measure may be based on a periodic function. One example of an expression for a time-difference based similarity measure S(t(a), t(b)) of two timestamps t(a) and t(b) is:

S(t(a), t(b))=1+cos(π|t(a)−t(b)|/4T).

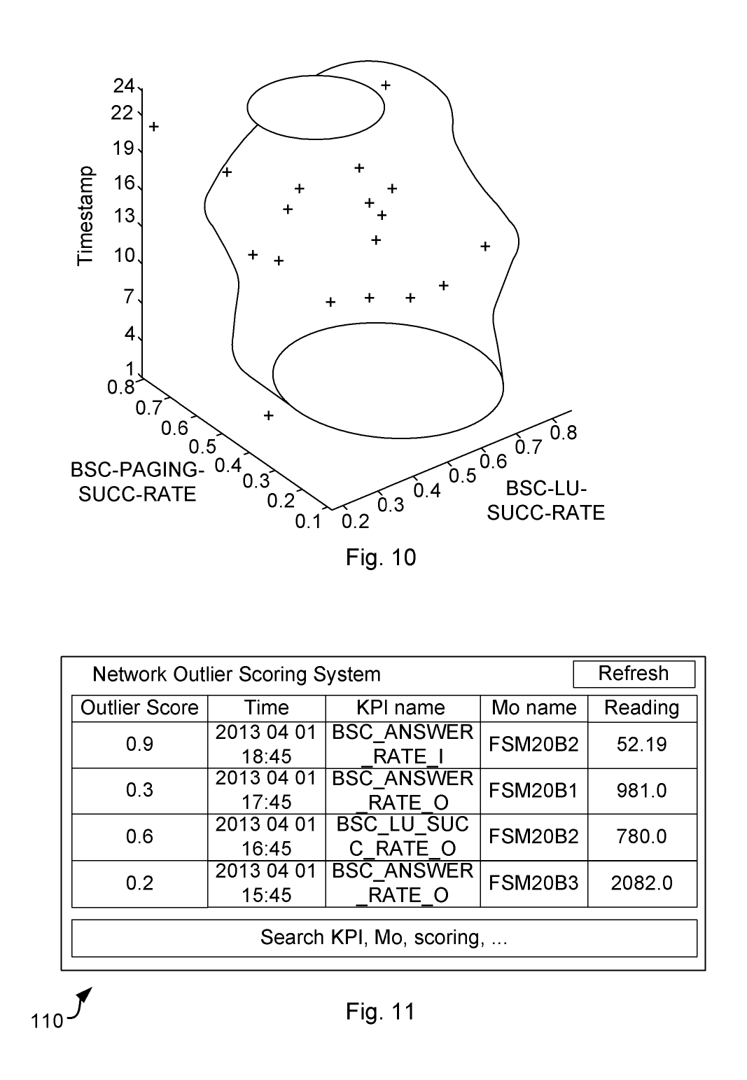

The period T may, for example, be set to 86,400 seconds (i.e., 24 hours) to signify the similarity of two daily recurrent timestamps. As the skilled person understands, the above expression is easily modified to consider similarities based on daily, weekly or other periods. These values may further be added to similarities based on KPI readings. FIG. 10 shows 2-dimensional vectors of KPI values as “+” signs from timestamp 1 to timestamp 24. The resultant 3-dimensional tube in the original KPI-timestamp space demonstrates the effect of excluding outliers from other data points. Multiple N-dimensional regions may thus be determined as disclosed above and be further induced by the similarities of all the timestamps. Thus, by encoding timestamp information into the similarity evaluation function, neighbouring and recurrent timestamps share large similarity. The 2-dimensional sphere in each time slice is irregular in the original KPI reading space. By joining all boundaries consecutively a tube is formed to exclude outliers. This tube may be extended backwards or forwards in time (i.e., towards timestamp 0 and timestamp 25, etc.)

In this respect it is also noted that if the pairwise similarity of two KPI vectors is determined by the inner product of said two KPI vectors (in other words, if their distance is the Euclidean distance), then the N-dimensional region will be an N-dimensional sphere. If a non-linear function is applied when determining the pairwise similarity, this will result in non-linear N-dimensional regions.

Expert input may be used to provide a priori information to shape boundaries between the N-dimensional regions. According to an embodiment the processing unit 21 of the network node 20 is arranged to, in an optional step S102b, acquire user input relating to location of at least one of the above disclosed first N-dimensional boundary, second N-dimensional boundary, and third N-dimensional boundary. The acquiring in step S102b may be performed by executing functionality of the acquire module 21a. The computer program 32 and/or computer program product 31 may thus provide means for this acquiring. For example, user/expert input may additionally or alternatively be used to assign (e.g., hard code) an outlier score to an N-dimensional vector of KPI value. According to an embodiment the processing unit 21 of the network node 20 is arranged to, in an optional step S102c, acquire user input relating to tagging the N-dimensional vector of KPI values with a predetermined outlier score. The acquiring in step S102c may be performed by executing functionality of the acquire module 21 a. The computer program 32 and/or computer program product 31 may thus provide means for this acquiring. Thus, by means of user/expert input an N-dimensional vector of KPI values can be tagged as an outlier or as a normal point (i.e., a non-outlier). With reference to FIG. 2c, user input may be received through the user input encoding module 21e and then provided to the space construction module 21d and/or the outlier scoring module 21f.

There may be different ways of determining the outlier score for the N-dimensional vector of KPI values as in step S104. According to the present embodiment the outlier score is inversely proportional to the number of N-dimensional boundaries enclosing the at least one N-dimensional vector. More generally, the outlier score for the N-dimensional vector may be inversely proportional to the number of N-dimensional regions Rk, k=1, . . . , L enclosing the N-dimensional vector. FIG. 7 schematically indicates N-dimensional outlier scoring regions based on the N-dimensional regions of FIG. 6. FIG. 9 schematically indicates N-dimensional outlier scoring regions based on the N-dimensional regions of FIG. 8. According to the example of FIG. 7, an N-dimensional vector V1 is given an outlier score in the interval 0.7-0.8, and According to the example of FIG. 9, the N-dimensional vector V1 is given an outlier score in the interval 0.71-0.86. Determination of the outlier score may be implemented in the outlier scoring module 21f of FIG. 2c. The outlier score may thus be based on input received from the space construction module 21d and optionally, also from the user input encoding module 21e.

Further, as noted above, the indication of service failure in step S106 may be based on comparing the outlier score to a predetermined threshold value, which threshold value in turn may be related to a likelihood value. The threshold value may be related to which type, or types, of network equipment devices the outlier score relates to; a gateway may be associated with a different threshold value than a router, etc. The outlier score may also be based on the topology of the network equipment devices, such as the absolute position of the network equipment device(s) or the relative position of the network equipment device(s) in the communications network 10. The relative position may be based on operational connections between the network equipment devices 11a, 11b, 15, 16, 17a, 17b.

The likelihood value may be set as a value between 0 and 1. Thus, in case the outlier score is higher than this value an indication of service failure is generated. The likelihood value may be determined by the number of N-dimensional regions that should cover an N-dimensional vector of KPI values for this N-dimensional vector of KPI values not to be classified as an outlier. The likelihood value may additionally and/or alternatively be determined by which of the N-dimensional regions that should cover the N-dimensional vector of KPI values for this N-dimensional vector of KPI values not to be classified as an outlier.

FIG. 11 schematically illustrates a user interface 110 of a network outlier scoring system for providing an indication of service failure for at least one network equipment device 11a, 11b, 15, 16, 17a, 17b. The user interface may be displayed on a screen. For each timestamp (as provided in the column named “Time” an outlier score (provided in the column named “Outlier Score”) is provided for KPI values of a particular type (as indicated in the column named “KPI name”) for a particular network equipment device 11a, 11b, 15, 16, 17a, 17b (as indicated in the column named “Mo name” where Mo is short for Module) together with a reading of the KPI value (as indicated in the column named “Reading”). Each row of data corresponds to one composite data post. A user is enabled to interact with the user interface 110 by requesting new readings to be displayed by interacting with the “Refresh” item. A user is further enabled to interact with the user interface 110 by searching for previously recorded data posts by interacting with the “Search KPI, Mo, scoring, . . . ” item. The user interface 110 may further be configured to perform an action, as in step S108. The performing in step S108 may be performed by executing functionality of the perform module 21c. The computer program 32 and/or computer program product 31 may thus provide means for this performing. This action may be to indicate a service failure alarm.

In summary there has been presented embodiments according to which KPI data points (as represented by N-dimensional vectors) may be transformed through a space construction component to a nonlinear space. KPI readings, time difference between KPI readings, and user/expert input may be used to determine a pairwise similarity between each pair of transformed data points. Multiple N-dimensional regions in the space where the KPI points are may be determined. A likelihood score for a data point of being an outlier (hence indicating failure in the communications system) may be determined by counting how many times each data point falls outside (or inside) these N-dimensional regions. Trained N-dimensional regions may be used for prediction of outliers from future KPI readings.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for indicating service failure in a communications network, the method being performed by a network node, comprising the steps of:
acquiring at least one N-dimensional vector of key performance indicator, KPI, values from at least one network equipment device;
determining an outlier score for said at least one N-dimensional vector by using an L-valued outlier scoring function based on N-dimensional regions Rk, k=1, . . . L, where L>1, and where region Ri is at least partly enclosed by region Rj, and wherein said outlier score for said N-dimensional vector is dependent on in which of said N-dimensional regions Rk said N-dimensional vector is located; and
determining an indication of service failure for said at least one network equipment device based on said outlier score for said at least one N-dimensional vector.

2. The method according to claim 1, wherein said outlier score for said N-dimensional vector is inversely proportional to number of N-dimensional regions Rk, k=1, . . . , L enclosing said N-dimensional vector.

3. The method according to claim 1, further comprising:
acquiring at least two further N-dimensional vectors of KPI values from said at least one network equipment device; and
determining said L-valued outlier scoring function by determining N-dimensional boundaries between region Ri and Region Ri+1 for i=1, . . . , L−1;
wherein all of said at least two further N-dimensional vectors are enclosed within a first N-dimensional boundary, said first N-dimensional boundary being based on distances between said all further N-dimensional vectors; and
wherein a proper subset of said at least two further N-dimensional vectors is enclosed within a second N-dimensional boundary, said second N-dimensional boundary being based on a distances between vectors of said proper subset.

4. The method according to claim 3, wherein a further proper subset of said at least two further N-dimensional vectors is enclosed by a third N-dimensional boundary, said further proper subset and said proper subset having a non-zero intersection and a non-zero set difference, said third N-dimensional boundary being based on a distances between vectors of said further proper subset.

5. The method according to claim 3, wherein said outlier score is inversely proportional to number of said N-dimensional boundaries enclosing said at least one N-dimensional vector.

6. The method according to claim 3, wherein each N-dimensional vector in each proper subset of said at least two further N-dimensional vectors is associated with a weighting factor, and wherein all weighting factors for said further N-dimensional vector in said each proper subset sum up to 1.

7. The method according to claim 6, wherein each one of said weighting factors is at most equal to C, where 0<C<1.

8. The method according to claim 3, further comprising:
acquiring user input relating to location of at least one of said first N-dimensional boundary, said second N-dimensional boundary, and said third N-dimensional boundary.

9. The method according to claim 1, wherein said N-dimensional regions by default are N-dimensional spheres.

10. The method according to claim 1, wherein said N-dimensional regions are defined by at least one N-dimensional non-linear function.

11. The method according to claim 1, further comprising:
acquiring user input relating to tagging said N-dimensional vector of KPI values with a predetermined outlier score.

12. The method according to claim 1, wherein said determining an indication of service failure score is based on comparing said outlier score to a predetermined threshold value.

13. The method according to claim 1, further comprising:
performing an action in response to said indication of failure.

14. The method according to claim 1, wherein said action is based on at least one of said outlier score and said N-dimensional vector of KPI values.

15. The method according to claim 1, wherein said at least one N-dimensional vector is associated with a timestamp.

16. The method according to claim 15, further comprising:
determining a similarity measure based on said timestamp between said at least one N-dimensional vector and at least one previously acquired N-dimensional vector of KPI values associated with a previous timestamp;
wherein said outlier score for said at least one N-dimensional vector is further determined based on said similarity measure, and an outlier score for said at least one previously acquired N-dimensional vector of KPI values.

17. The method according to claim 1, wherein said N-dimensional vector represents KPI values from a plurality of network equipment devices.

18. The method according to claim 1, wherein said N-dimensional vector represents KPI values from a single network equipment device.

19. The method according to claim 1, wherein said N-dimensional vector represents KPI values with a common timestamp value.

20. The method according to claim 1, wherein said N-dimensional vector represents KPI values with at least two different timestamp values.

21. The method according to claim 1, wherein said at least one network equipment device is any of a gateway, a router, a network bridge, a switch, a hub, a repeater, a multilayer switch, a protocol converter, a bridge router, a proxy server, a firewall handler, a network address translator, a multiplexer, a network interface controller, a wireless network interface controller, a modem, an Integrated Services for Digital Network, ISDN, terminal adapter, a line driver, a wireless access point, a radio base station, or any combination thereof.

22. A network node for indicating service failure in a communications network, the network node comprising a processing unit and a non-transitory computer readable storage medium, said non-transitory computer readable storage medium comprising instructions executable by said processing unit whereby said network node is operative to:
acquire at least one N-dimensional vector of key performance indicator, KPI, values from at least one network equipment device;
determine an outlier score for said at least one N-dimensional vector by using an L-valued outlier scoring function based on N-dimensional regions Rk, k=1, . . . , L, where L>1, and where region Ri is at least partly enclosed by region Rj, and wherein said outlier score for said N-dimensional vector is dependent on in which of said N-dimensional regions Rk said N-dimensional vector is located; and
determine an indication of service failure for said at least one network equipment device based on said outlier score for said at least one N-dimensional vector.

23. A computer program product for indicating service failure in a communications network, the computer program product being stored on a non-transitory computer readable storage medium and comprising computer program instructions that, when executed by a processing unit, causes the processing unit to:
acquire at least one N-dimensional vector of key performance indicator, KPI, values from at least one network equipment device;
determine an outlier score for said at least one N-dimensional vector by using an L-valued outlier scoring function based on N-dimensional regions Rk, k=1, . . . , L, where L>1, and where region Ri is at least partly enclosed by region Rj, and wherein said outlier score for said N-dimensional vector is dependent on in which of said N-dimensional regions Rk said N-dimensional vector is located; and
determine an indication of service failure for said at least one network equipment device based on said outlier score for said at least one N-dimensional vector.

24. A network node for indicating service failure in a communications network, the network node comprising:
an acquire module for acquiring at least one N-dimensional vector of key performance indicator, KPI, values from at least one network equipment device;
a determine module for determining an outlier score for said at least one N-dimensional vector by using an L-valued outlier scoring function based on N-dimensional regions Rk, k=1, . . . , L, where L>1, and where region Ri is at least partly enclosed by region Rj, and wherein said outlier score for said N-dimensional vector is dependent on in which of said N-dimensional regions Rk said N-dimensional vector is located; and
a determine module for determining an indication of service failure for said at least one network equipment device based on said outlier score for said at least one N-dimensional vector.
